(19) United States
(12) Patent Application Publication
(10) Pub. No.: US 2020/0254534 A1
(43) Pub. Date: Aug. 13, 2020

(54) COMBINATION DRILL, MILL, AND BORING TOOL

(71) Applicant: KYOCERA SGS PRECISION TOOLS, INC., MUNROE FALLS, OH (US)

(72) Inventors: Ian Edward HOLLIDAY, Basingstoke, Hampshire (GB); Emil DOBOSZ, Wokingham, Berkshire (GB); Barry Leslie WARD, Wokingham, Berkshire (GB); Antony James THEAKER, West Park, Leeds (GB)

(21) Appl. No.: 16/647,264

(22) PCT Filed: Sep. 12, 2018
(86) PCT No.: PCT/US2018/050685

§ 371 Date: Mar. 13, 2020

Related U.S. Application Data
(60) Provisional application No. 62/558,003, filed on Sep. 13, 2017.

(51) Int. Cl. B23B 51/08; B23C 5/10

(52) U.S. Cl. CPC B23B 51/08; B23C 2210/247; B23B 2270/56; B23C 5/10

(57) ABSTRACT

Disclosed is a combination tool having a plurality of cutting elements. According to one embodiment, the combination tool comprises a drilling portion, a milling portion, and a boring portion. In this embodiment, the combination tool may perform a drilling operation, a milling operation, and a boring operation in quick succession with a single cutting tool. In another embodiment, the combination tool includes an additional cutting element such as a chamfering portion, which may perform a countersinking operation.

### CROSS-REFERENCE TO RELATED APPLICATIONS

This application claims priority to and the benefit of pending U.S. Provisional Application No. 62/558,003 filed on Sep. 13, 2017, which is incorporated by reference herein in its entirety.

### TECHNICAL FIELD

The present disclosure is directed to a tool and, in particular, a tool having a plurality of cutting portions that is capable of performing a combination of cutting operations.

### BACKGROUND

Combination tools are used by a variety of industries during material removal operations where it is desirable for a single tool to perform more than one operation on workpiece. This is especially true of machine shops utilizing interpolated milling methods to consolidate material removal operations. Combination tools may include a variety of different cutting elements to achieve these various cuts. For example, the tool may include a mill portion and a drill portion or may include a mill portion and a bore portion. The cutting elements of a combination tools may be selected based on the tolerances required of the finished workpiece, its surface finish, or various processing parameters.

The combination tool's cutting elements, however, may affect its performance during a material removal operation, as evaluated by heat generated by the combination tool, material removal rates, and surface finish of the workpiece. Some of these effects may adversely impact the material removal operation and/or the finished workpiece. The combination tool may, for example, generate heat when operating on workpieces that require tight tolerances and high quality surface finish, and such heat generation may cause the formation (on the workpieces) of certain undesirable materials or coatings that would later need to be removed via subsequent operations. Such subsequent operations typically require time consuming retooling and/or otherwise result in extra downtown between machining operations, either of which adversely impacts machine shops' efficiencies and bottom lines.

Accordingly, a single tool capable of drilling, milling, and boring may be desired to form high quality cuts in workpieces without excessive heat buildup or other adverse effects.

### SUMMARY

The present disclosure is directed towards a cutting tool having a combination of cutting portions. The cutting tool may include a drill portion, a mill portion, and/or a bore portion, where a diameter of the mill portion is smaller than a diameter of the drill portion. In some embodiments, the diameter of the bore portion is larger than the diameter of the mill portion and in some of these embodiments, the diameter of the bore portion is greater than the diameter of the drill portion. In some embodiments, the drill portion, the mill portion, and/or the bore portion are each positioned along a central axis of the cutting tool, and in some of these embodiments, the mill portion is between the drill portion and the bore portion. In some of these embodiments, the drill portion is provided at an axial end of the cutting tool. Gaps may be provided between the drill portion and the mill portion and/or between the mill portion and the bore portion.

The cutting tool may also include a chamfer portion. The chamfer portion may be positioned on a side of the bore portion that is opposite from the axial end, and a gap may be provided between the bore portion and the chamfer portion or the chamfer portion may abutt the bore portion. The chamfer portion may instead be positioned between the mill portion and the bore portion, and a gap may be provided between the mill portion and the chamfer portion and/or between the chamfer portion and the bore portion.

The present disclosure is also directed towards method of machining a workpiece using a cutting tool having a drill portion, a mill portion, and/or a bore portion. The method may include the steps of drilling a hole in the workpiece with the drill portion; milling the hole in the workpiece with the mill portion in an interpolated milling operation, wherein the mill portion includes a diameter that is smaller than a diameter of the drill portion; and boring the hole in the work piece with the bore portion. The method may also be utilized with the cutting tool that further includes a chamfer portion, such that the method further includes chamfering the hole in the workpiece with the chamfer portion.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a side view of an exemplary tool according to one or more embodiments.

FIG. 2 is a representation illustrating the tool of FIG. 1 performing an exemplary drilling operation followed by an exemplary milling operation.

FIG. 3 is a representation illustrating the combination tool of FIG. 1 performing an exemplary boring operation followed by an exemplary chamfering operation.

FIG. 4 sets forth exemplary parameters of the material removal operations illustrated in FIGS. 2-3, according to one or more embodiments.

### DETAILED DESCRIPTION

Reference will now be made in detail to embodiments of a tool capable of performing a number of different cutting operations in succession. The tool includes a plurality of cutting portions such as, for example, a drilling portion, a milling portion, and a boring portion. Optionally, the tool may include additional cutting portions such as, for example, a chamfering portion. Inclusion of multiple cutting portions permits a single tool to perform multiple machining operations in quick succession without retooling. For example, the tool according to one or more embodiments disclosed herein may perform a drilling operation, a milling operation, a boring operation and, where included, a chamfering operation, and the tool may perform all of these combination of operations in quick succession and without utilization of other cutting tools. Thus, tools according to the present disclosure may provide improved cycle times.

The tool according to the present disclosure may eliminate the need for a reaming operation, which may not introduce a desired surface finish to the workpiece. The tool herein disclosed may also eliminate the need for subsequent operations, such as a chemical milling operation, in which select material is removed from the workpiece following the operation that forms the hole or recess. For example, excessive heat generation may occur during machining operations on workpieces that require tight tolerances and high qualify surface finish, and this resulting heat buildup may cause formation of certain undesirable materials/coatings that must be subsequently removed by a separate material removal operation (e.g., a chemical milling operation); however, this subsequent material removal operation may be eliminated by utilizing a tool having a plurality of cutting portions as disclosed herein. For example, where the workpiece is a high temperature alloy (e.g., titanium) fan or rotor for a rotating disc (that requires tight tolerances and a high qualify surface finish), alpha case (i.e., a brittle oxide of titanium) may form on the workpiece when temperatures rise above a threshold temperature of about eight hundred degrees Fahrenheit (800° F.), and the tool may include one or more cutting elements (e.g., in a milling portion) that removes the alpha case material without retooling for subsequent material operations.

Tools according to the present disclosure may be made with a variety of conventionally known materials that are suitable for a material removal operation. Such materials include, without limitation, cemented tungsten carbide (including cemented cobalt tungsten carbide) and various grades of tool steel. Moreover, the surfaces of the presently disclosed tools may be coated with dissimilar materials to improve certain properties of the tool, and such coatings include without limitation ceramic coatings, such as TiN, TiC, and TiAlN. In addition, one or more of the cutting portions of the tool may be coated with different coatings that one or more of the other cutting portions.

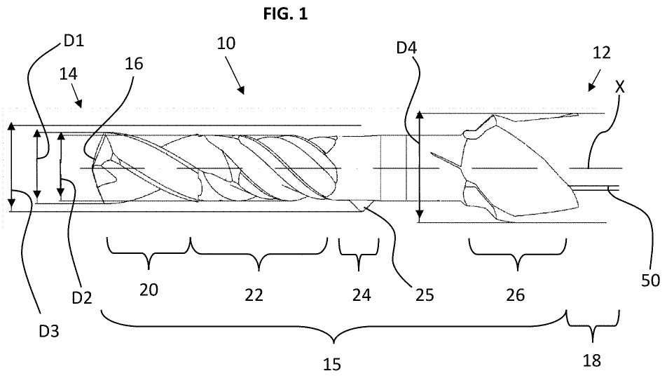

FIG. 1 depicts a tool 10 for performing a combination of different material removal processes, according to one or more embodiments.

Because the tool 10 may be utilized in more than one successive material removal operations, or a combination of material removal operations, the tool 10 is sometimes referred to as a combination tool or multi-operation tool. As hereinafter described, the tool illustrated in FIG. 1 is configured with a combination of cutting segments and cutting features, including a drill, a mill, a single point-bore, and a front and back chamfer; however, the tool 10 may be differently configured with other combinations of cutting segments and features without departing from the present disclosure.

The tool 10 extends along a central axis X and includes a proximal end 12 and a distal end 14 (sometimes referred to as an axial end 14). The tool 10 includes a cutting portion 15 that extends proximally from the distal end 14 towards the proximal end 12, and the cutting portion 15 includes an axial cutting face 16 arranged at the distal end 14 for engaging a work piece as the tool 10 is plunged there-into during a drilling operation. The tool 10 may also include a shank portion 18 that extends proximally from (a proximal end of) the cutting portion 15. Here, the shank portion 18 is arranged at the proximal end 12 (of the tool 10). The shank portion 18 may provide the means by which a piece of equipment (not illustrated) may grab (or attach to) the tool 10. In some embodiments, the shank portion 18 includes a uniform shank portion that extends proximally along the central axis X with a uniform diameter and is attached within a piece of equipment; whereas in other embodiments, the shank portion 18 also includes a tapered portion that extends from (a proximal end of) the cutting portion 15, thereby reducing (or increasing) the cutting portion 15 diameter relative to the uniform diameter of the uniform shank portion that extends proximally from the tapered portion.

In the illustrated embodiment, the cutting portion 15 of the tool 10 includes a drilling portion 20, a milling portion 22, and a boring portion 24 that are respectively arranged along the central axis X of the tool 10, from the distal end 14 towards the proximal end 12, as illustrated in FIG. 1. The tool 100 may optionally include a chamfering portion 26. In the illustrated example of FIG. 1, the chamfering portion 26 is arranged along the central axis X at a location that is proximal of the boring portion 24 and proximate to the proximal end 12 of the tool 10. The drilling portion 20, the milling portion 22, the boring portion 24, and the chamfering portion 26 are sometimes individually referred to as a “Cutting Portion” and collectively referred to as the “Cutting Portions.” In the illustrated embodiments, Cutting Portions are sequentially positioned along a central axis X of the combination tool 10 from its distal end 14 towards its proximal end 12. FIG. 1 illustrates an example sequence of Cutting Portions, where the drilling portion 20, the milling portion 22, the boring portion 24, and the chamfering portion 26 sequentially extend from the distal end 14 towards the proximal end 12. In other embodiments, however, the sequence Cutting Portions may be varied. For example, the chamfering portion 26 may be arranged between the milling portion 22 and the boring portion 24. In addition, the cutting portion 15 may include one or more additional cutting segments in addition to, or in lieu of, the above described Cutting Portions. For example, the cutting portion 15 may include two or more of the drilling portion 20, the milling portion 22, the boring portion 24, and/or the chamfering portion 26. Also, the cutting portion 15 may other cutting segments in addition to the drilling portion 20, the milling portion 22, the boring portion 24, and/or the chamfering portion 26, and such additional other cutting segments may include a back chamfer, a counter-bore and chamfer, etc.

The drilling portion 20 and the milling portion 22 each include a plurality of flutes and respective lands that helically extend, around the tool 10, proximally along the central axis X from the distal end 14. The intersection between the flutes and lands of the drilling portion 20 and the milling portion 22 define respective cutting edges. The drilling portion 20 and the milling portion 22 may have varying numbers of flutes, lands, and cutting edges depending on the end use application. In the illustrated embodiment, the drilling portion 20 and the milling portion 22 have the same number of flutes, such that the flutes of the drilling portion 20 extend into the flutes of the milling portion 22. However, the drilling portion 20 and the milling portion 22 may have different numbers of flutes. In addition, the chamfering portion 26 may include the same or a different number of flutes from either or both of the drilling portion 20 and the milling portion 22. In the illustrated embodiment, the chamfering portion 26 includes less flutes than the drilling portion 20 and the milling portion 22; however, in other embodiments, the chamfering portion 26 may include an equal or greater number of flutes compared to the drilling portion 20 and the milling portion 22. Moreover, the boring portion 24 includes a tooth 25. In the illustrated embodiment, the boring portion 24 is configured as a single point bore having one tooth 25; however, in other embodiments, the boring portion 24 may include one or more additional teeth (not illustrated) that may be aligned with the tooth 25 (along the central axis X) or axially offset along the central axis X relative to the tooth 25, and these one or more additional teeth may be the same as the tooth 25 or any of them may be differently configured than the tooth 25.

As illustrated, the drilling portion 20 may be positioned along the central axis X proximate to the distal end 14 of the tool 10 and may define a drill diameter D1. In addition, the drilling portion 20 may be configured as any number of drills without departing from the present disclosure. The milling portion 22 may be positioned proximal of the drilling portion 20 and may define a mill diameter D2. In the illustrated embodiment, the milling portion 22 is configured as an end mill and abuts (a proximal end of) the drilling portion 20, but in other embodiments, a gap may extend between the milling portion 22 and the drilling portion 20. The boring portion 24 may be positioned proximal of the milling portion 22 and may define a bore diameter D3. In the illustrated embodiment, a gap extending along the central axis X is provided between the boring portion 24 and the milling portion 22; however, in other embodiments, the gap is smaller or larger than that illustrated in FIG. 1. In even other embodiments, the boring portion 24 abuts (a proximal end of) the milling portion 22 such that no gap extends there-between. Where utilized, chamfering portion 26 may define a chamfer diameter D4. In the illustrated embodiment, the chamfering portion 26 is positioned proximally of the boring portion 24 and a gap extends along the central axis X between the chamfering portion 26 and the boring portion 24, thereby separating the chamfering portion 26 from the boring portion 24. The gap between the chamfering portion 26 and the boring portion 24 may have various lengths, and in some embodiments there is no such gap such that the chamfering portion 26 abuts (a proximal end of) the boring portion 24.

The drill diameter D1, the mill diameter D2, the bore diameter D3, and the chamfer diameter D4 may have varying dimensions depending on the particular end use application, and their values relative to each other may vary. For example, the drill diameter D1, the mill diameter D2, the bore diameter D3, and the chamfer diameter D4 may all have the same value, may all have different values, or two or more of them may have the same value. In the exemplary embodiment of FIG. 1, the drill diameter D1 of drilling portion 20 is larger than the mill diameter D2 of milling portion 22 (i.e., D1>D2), and the bore diameter D3 of the boring portion 24 is larger than the drill diameter D1 of the drilling portion 20 (i.e., D3>D1). It will be appreciated, however, that the bore diameter D3 of the boring portion 24 may vary and, depending on the particular end use application, may be smaller than the drill diameter D1 of the drilling portion 20 (i.e., D1>D3) and may sometimes be smaller than the mill diameter D2 of the milling portion 22 (i.e., D2>D3). In some of these examples, the chamfer diameter D4 is larger than the bore diameter D3 (i.e., D4>D3). In one example, the drill diameter D1 is about 6.5 millimeters (“mm”), the mill diameter D2 is about 6 mm, and the bore diameter D3 is about 8 mm. In another example where tool 10 further includes the chamfering portion 26, the drill diameter D1 is about 6.5 mm, the mill diameter D2 is about 6 mm, the bore diameter D3 is about 8 mm, and the chamfer diameter D4 is about 10 mm and configured to form a chamfer or countersink having an about 8.6 mm diameter. It will also be appreciated that, depending on the particular end use application, any or all of the Cutting Portions (i.e., the drilling portion 20, the milling portion 22, the boring portion 24, and the chamfering portion 26) may be differently arranged, organized, or positioned along the length of combination tool 10.

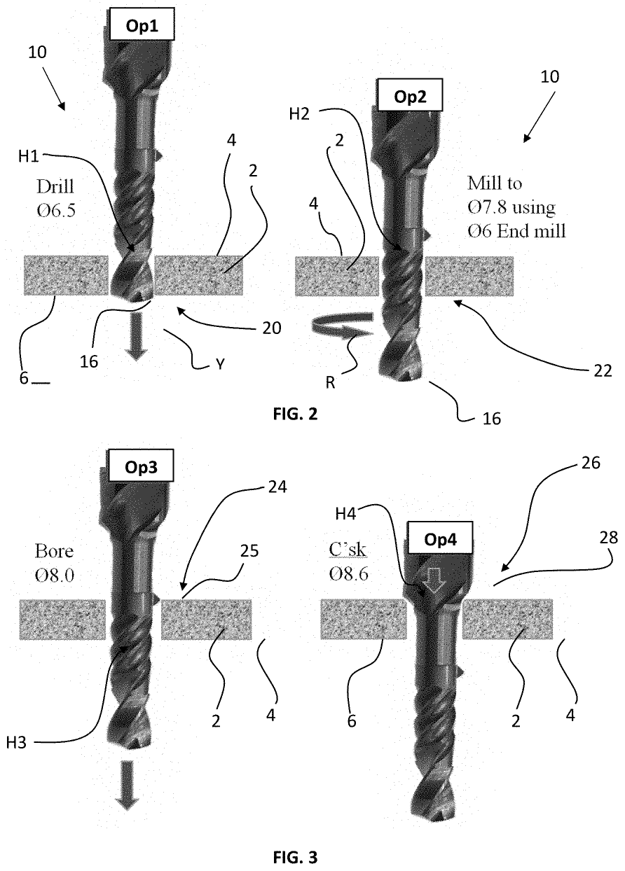

FIGS. 2 and 3 illustrate the tool 10 of FIG. 1 performing an exemplary machining operation on a workpiece 2 having a top surface 4 and a bottom surface 6, according to one or more embodiments. When in use, the tool 10 may be first rotated (about the central axis X of the tool) at a fixed position, and then plunged in a downward direction Y along the central axis X into the workpiece 2 to cut a drill hole H1 through the workpiece 2, from the top surface 4 through the bottom surface 6, via the drilling portion 20, and this operation is referred to as a drilling operation and identified as “Op1” in FIG. 2. The tool 10 may then subsequently translated in the downward direction Y to a depth where the milling portion 22 is disposed within the drill hole H1 that was previously formed in the workpiece 2. The tool 10 is then simultaneously rotated (about the central axis X) and orbited along a tool path R such that the milling portion 22 removes material from the sides of the drill hole H1, thereby enlarging the drill hole H1 into a milled hole H2, and this subsequent operation is referred to as a milling operation and identified as “Op2” in FIG. 2. Thus, the milling operation (Op2) may be utilized to enlarge the diameter of the drill hole H1. The tool path R utilized in the milling operation (Op2) may include various paths depending on the end use application, and in one example the tool path R is a circular interpolation.

The milling operation (Op2) may impart lower temperatures to the workpiece 2 than what was imparted during the drilling operation (Op1), but the surface finish of the workpiece 2 (i.e., of the milled hole H2) may nevertheless be unsatisfactory for some end use applications. Moreover, it may be desirable to further enlarge the diameter of the milled hole H2, for example to provide greater accuracy of the diameter, and/or to otherwise further machine the milled hole H2 (e.g., to provide a taper, etc.). Accordingly, the boring portion 24 of the tool 10 may be rotated about the central axis X and brought into engagement with the workpiece 2 to perform a boring operation, which is identified as “Op3” in FIG. 3. During the boring operation (Op3), the boring portion 24 may be used to remove a small amount of material from the workpiece 2 and, moreover, provide a high quality surface finish to the workpiece 2. Thus, the boring operation (Op3) may be utilized to enlarge the milled hole H2 into a bored hole H3. In some embodiments of the boring operation (Op3), the tool 10 may rotate about the central axis X and translate relative to the workpiece 2 along the central axis X, for example, translate towards or through the workpiece 2 in the downward direction Y. In other embodiments, the combination tool 10 may simultaneously be rotated about the central axis X and orbited about a tool path (e.g., the tool path R) to remove material from the workpiece 2 during the boring operation (Op3).

After the boring operation (Op3) has been performed for form the bored hole H3, the tool 10 may be configured to perform a chamfering operation identified as “Op4” in FIG. 3. As previously mentioned, tool 10 may optionally include a chamfering portion 26, and such chamfering portion 26 may further comprise a countersink cutter 28. Here, the chamfering portion 26 is provided at the proximal end 12 of the tool, proximal from the boring portion 24. During the chamfering operation (Op3), the tool 100 may be rotated about the central axis X and translated along the central axis X in the downward direction Y towards the workpiece 2. The chamfering portion 26 engages at least a portion of the bored hole H3 of the workpiece 2, thereby forming a chamfered hole H4. Where the chamfering portion 26 includes the countersink cutter 28, the chamfered hole H4 may include a countersink feature cut into the top surface 4 of the workpiece 2. Accordingly, the tool 10 may be positioned within the bored hole 3 and translated to introduce the countersink cutter 28 into the bored hole H3 after completion of the boring operation (Op3). However, the chamfering operation (Op4) may instead be performed following either the drilling operation (Op1) or the milling operation (Op2), instead.

As previously disclosed, the tool 10 may be utilized to provide a plurality of material removal processes in rapid succession, including but not limited to, one or more of the following: the drilling operation (Op1), the milling operation (Op2), the boring operation (Op3), and the chamfering operation (Op4). In some embodiments, one or more of the foregoing are performed sequentially (i.e., the drilling operation (Op1), then the milling operation (Op2), then the boring operation (Op3), and then the chamfering operation (Op4)). In other embodiments, however, they are performed in various other non-sequential orders, and such non-sequential orders of operation may or may not depend on the positioning of the cutting portions (i.e., the drilling portion 20, the milling portion 22, the boring portion 24, and/or the chamfering portion 28) relative to each other along the central axis X. For example, the tool 10 may be provided with the milling portion 22 located at the axial face 16 such that the milling portion 22 is utilized to create the first hole via a plunge milling operation.

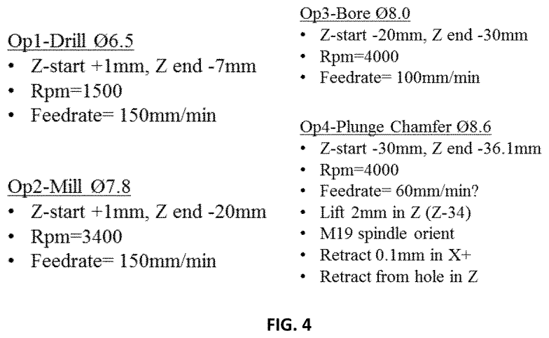

FIG. 4 is a table of exemplary parameters that may be utilized to perform the material removal operations illustrated in FIGS. 2-3, according to one or more embodiments. Thus, the tool 100 may be utilized to perform sequentially the drilling operation (Op1), the milling operation (Op2), the boring operation (Op3), and (optionally) the chamfering operation (Op4) as set forth in the following paragraphs.

First, the workpiece 2 to be machined is placed within a suitable machining tool (not depicted) such as, for example, a computer numerical control (“CNC”) machining center (“Machining Center”). Then the tool 10 is installed and positioned therein so that its distal tip or axial cutting face 16 is spaced above the top surface 4 of the workpiece 2. In this example, the axial cutting face 16 is initially spaced about 1 mm above the top surface 4. Thereafter, a first material removal process commences, which may include utilization of any number of cutting tools. In the present example, the first material removal process is the drilling operation (Op1) utilizing the drilling portion 20 of the tool 10. Here, the drilling operation (Op1) commences with the tool 10 rotating about the central axis X thereof at a speed of about 1,500 revolutions per minute (“RPM”) and being fed in the downward direction Y towards the top surface 4 and into the workpiece 2 at a feedrate of about one hundred and fifty (150) millimeters per minute (“mm/min”), so as to plunge the axial cutting face 16 of the tool 10 into the workpiece 2 to a depth of about seven (7) mm below the top surface 4 of workpiece 2, thereby creating the drill hole H1 having a diameter that is about equal to the drill diameter D1 of drilling portion 20. In other examples, the tool 10 may start and stop at different distances above and below the top surface 4, depending on the end use application and/or the workpiece to be machined. The drilling operation (Op1) causes the drilling portion 20 to engage the workpiece 2 so as to remove the desired portion(s) thereof, which in turn results in the drill hole H1. In some embodiments, the drilling operation (Op1) includes a peck drilling cycle. The drilling operation (Op1) concludes once the drill hole H1 has been suitably formed within the workpiece 2 via the drilling portion 20 and, if no further material removal is needed, the tool 10 may be withdrawn therefrom. If further material removal operations are to be performed, however, the conclusion of the drilling operation (Op1) marks the beginning of at least a second material removal process, for example, the beginning of the milling operation (Op2). However, the boring operation (Op3) or the chamfering operation (Op4) may instead follow the drilling operation (Op1), and one or more material removal operations may subsequently follow thereafter. At the conclusion of the drilling operation (Op1), the tool 10 may cease rotation about the central axis X, or immediately ramp up or down to another rotational speed as specified in a subsequent material removal operation. FIG. 4 details the parameters utilized in this exemplary drilling operation (Op1).

A second material removal process is then performed. The second material removal process may also involve any number of cutting tools and commences following completion of the first material removal process such as, for example, following completion of the drilling operation (Op1). In this example, the second material removal operation is the milling operation (Op2) where the milling portion 22 having the mill diameter D2 is utilized to enlarge the drill hole H1 and/or otherwise remove desired portion(s) of the workpiece 2. The milling operation (Op2) may include a plunge process followed by an interpolated milling process. For example, the milling operation (Op2) may include a first step where the combination tool 10 plunges in the downward direction Y towards the workpiece 2 and into the drill hole H1 until the milling portion 22 is within the drill hole H1 formed in the prior drilling operation (Op1), at which time an interpolated milling process may be utilized to interpolate the drill hole H1 to a desired size. Thus, the tool 10 does not start interpolating until it is already within the drill hole H1 formed in the drilling operation (Op1); however, in other embodiments, the tool 10 begins an interpolating process at a location above the workpiece 2, after which the tool 10 is plunged into the workpiece 2 while interpolating. Various interpolated drilling procedures may be utilized, for example, a circle interpolating process (i.e., orbital drilling) where the tool 10 is operated in a tool path that follows circular interpolation, a helical interpolating process where the tool 10 is operated in a tool path that follows a helical interpolation, etc. It will be appreciated, however, that other tool paths may be followed when utilizing the interpolated drilling process and, moreover, that other drilling processes may be utilized.

The milling operation (Op2) begins with the tool 10 being translated in the downward direction Y such that the boring portion 22 is positioned within drill hole H1. Once the boring portion 22 is in the drill hole H1, the tool 10 may commence rotation about the central axis X; or, if the tool 10 did not cease rotation following culmination of a prior material removal operation, the rotational speed of the tool 10 may be increased or decreased as needed when the boring portion 22 is within the drill hole H1.

Alternatively, the tool 10 may be rotating, at a speed of a prior material removal process or at a speed specified for the milling operation (Op2), before it translates along the central axis X in the downward direction Y to position the boring portion 22 within the drill hole H1. Accordingly, the tool 10 may commence rotation about the central axis X when the axial cutting face 16 of the tool 10 is in the same position as it was at the end of the prior material removal process.

In operation, the milling operation (Op2) may commence once the axial cutting face 16 at the distal end 14 of tool 10 is repositioned, for example, to a distance of about 1 mm above the top surface 4 of the workpiece 2. In other examples, the milling operation (Op2) may commence when the tool 10 has been repositioned such that the milling portion 22 is within the drill hole H1. During the milling operation (Op2), the tool 10 begins rotating along its central axis X at a specified RPM and then plunges in the downward direction Y into the drill hole H1 at a specified feedrate. Alternatively, the tool 10 begins rotating after the milling portion 22 has been positioned within the drill hole H1. Once the milling portion 22 is within the drill hole H1 formed in the drilling operation (Op1) at the desired location, it begins operating in a tool path following the circular interpolation R. Accordingly, the milling portion 22, via interpolated milling, enlarges the drill hole H1 into the milled hole H2 having a larger diameter that is defined by a diameter of the circular interpolation R. In one such exemplary milling process (Op2), the tool 10 rotates about the central axis X at a speed of about 3,400 RPM while being fed in the downward direction Y towards and into the workpiece 2 at a feedrate of about 150 mm/min, so as to plunge the axial cutting face 16 of the tool 10 into the workpiece 2 to a depth of about twenty (20) mm below the top surface 4 of the workpiece 2. Once at that depth, the combination tool 10 begins to interpolate following the circular interpolation R (or other tool path) having a tool path diameter of about 7.8 mm. This example of the milling operation (Op2) causes milling portion 22 to engage the drill hole H1 of the workpiece 2 so as to remove (interpolate) additional material therefrom, resulting in the mill hole H2, which has a diameter that is about equal to the tool path following the circular interpolation R. The milling process (Op2) concludes once a larger hole, such as the mill hole H2, has been suitably machined into the workpiece 2 and, as detailed below, a third material removal process may be initiated immediately thereafter. FIG. 4 details the parameters utilized in this exemplary milling operation (Op2).

The third material removal process may involve any number of cutting tools and commences following completion of the second material removal process such as, for example, following completion of the milling process (Op2). In this example, the third material removal process is the boring operation (Op3) where boring portion 24 having the bore diameter D3 is utilized to remove desired portion(s) of the workpiece 2, for example, from within the previously enlarged milled hole H2. The boring operation (Op3) may begin immediately upon completion of the prior material removal process and without withdrawing the tool 10 from the workpiece 2. The boring portion 24 may commence rotation about the central axis X when the axial cutting face 16 of the tool 10 is in the same position as it was at the end of the prior material removal process. In other embodiments, the axial cutting face 16 of the tool 10 is plunged further into the workpiece 2 before commencing rotation, whereas, in even other embodiments the tool 10 is fully with drawn from the workpiece before commencing rotation.

Accordingly, the boring portion 24 may instead commence rotation about the central axis X, for example, at a speed of about 4,000 RPM, after the axial cutting face 16 of the tool 10 translates from a position that is about 20 mm below the top surface 4 of the workpiece 2 to a position that is about 30 mm below the top surface 4 of the workpiece 2. Once rotating, the tool 10 may then continue to be fed into the workpiece 2 in the downward direction Y and at a feedrate of about one hundred (100) mm/min. Alternatively, the boring portion 24 may commence rotation about the central axis X when the axial cutting face 16 is about twenty (20) mm below the top surface 4 and then, while rotating, plunge into the workpiece 2 until the axial cutting face 16 is about thirty (30) mm below the top surface 4 of the workpiece 2. The tool 10 may rotate about the central axis X at various speeds during the boring operation (Op3) and, in the depicted example, the tool 10 rotates at a speed of about 4,000 RPM. The boring operation (Op3) concludes once the boring portion 24 has removed the desired about of material from workpiece 2 such that the milled hole H2 has been enlarged into the bored hole H3 and, at this time, the tool 10 may be fully withdrawn from the workpiece 2 and the workpiece 2 may be removed from the piece of equipment being utilized (e.g., a CNC Machining Center). In some embodiments, before the tool 10 is withdrawn from the bored hole H3 or otherwise fully removed from the workpiece 2, the tool 10 may be first offset in a lateral direction opposite of the boring tooth 25 of the boring portion 24 (i.e., in a direction radial outward from the central axis X), so as to provide clearance for the tool 10 as it is withdrawn such that it doesn't score the bored hole H3 formed into the workpiece 2. In one such example embodiment, the tool 10 is first offset by about 0.1 mm to provide clearance for the boring tooth 25 before the tool 10 is withdrawn from the bore hole H3. This marks the end of the entire material removal operation unless the tool 10 includes an additional Cutting Portion, such as the chamfering portion 26. FIG. 4 details the parameters utilized in this exemplary embodiment of the boring operation (Op3).

However, where the tool 10 includes a fourth Cutting Portion, for example, the chamfering portion 26, conclusion of the third material removal process may instead mark the beginning of an optional, fourth material removal process as discussed below.

The optional fourth material removal process may involve any number of cutting tools and may commence, if at all, following completion of a third material removal process such as, for example, following completion of the boring operation (Op3). A fourth material removal process may be utilized to remove additional material from the workpiece 2 so as to form, for example, a conical hole or countersink. In this example, the fourth material removal process is a chamfering operation (Op4) where the chamfering portion 26 having the chamfer diameter D4 is plunged into the top surface 4 of the workpiece 2 to form a countersink or chamfer H4 in the bored hole H4 proximate to the top surface 4; however, in other embodiments the chamfering operation (Op4) may be performed via interpolation rather than just plunging. As with the prior third material removal process (i.e., the boring operation (Op3)), the chamfering operation (Op4) may commence immediately upon completion of the prior material removal process without withdrawing the tool 10 from the bored hole H3 previously formed into the workpiece 2. Accordingly, the chamfering portion 26 may commence rotation about the central axis X when the axial cutting face 16 of the tool 10 is in the same position as it was at the end of the prior material removal process. In other embodiments, the axial cutting face 16 of tool 10 is plunged further into the workpiece 2 before commencing rotation, or the tool 10 is fully removed from the workpiece 2 prior to commencing further rotation. Accordingly, the chamfering portion 26 may commence rotation about the central axis X, for example, at a speed of about 4,000 RPM, after the axial cutting face 16 of the tool 10 translates from a position that is about thirty (30) mm below the top surface 4 of the workpiece 2 to a position that is about 36.1 mm below the top surface 4 of workpiece 2. Once the chamfering portion 26 has commenced rotation it may be fed into and withdrawn from the workpiece 2 at a feedrate of, for example, sixty (60) mm/min, thereby forming a countersink. In the illustrated example, following rotation of the chamfering portion 26 the tool 10 is raised approximately two (2) mm from the position where the axial cutting face 16 is about 36.1 mm below the top surface 4, such that the axial cutting face 16 is about 34.1 mm below the top surface 4 of the workpiece 2. Once the countersink H4 has been formed via the chamfering operation (Op4), the material removal process may be deemed complete and the workpiece 2 may be removed from the piece of equipment being utilized (e.g., a CNC Machining Center). As with the boring operation (Op3) detailed above, after conclusion of the chamfering operation (Op4) but before removal of the tool 10 from the hole formed into the workpiece 2, the tool 10 may be first offset in a lateral direction (e.g., in a direction opposite of the boring tooth 25 of the boring portion 24), so as to provide clearance for the tool 10 as it is withdrawn such that the boring tooth 25 doesn't score the hole just formed into the workpiece 2. FIG. 4 provides additional parameters utilized in this exemplary chamfering operation (Op4).

In some embodiments, the chamfering operation (Op4) further includes a second chamfering operation. For example, the chamfering portion 26 may be utilized to form a “front chamfer” in a front side (i.e., the top surface 4) of the workpiece 2 and, once that front chamfer has been formed via the chamfering portion 26, but before retracting the tool 10 from the hole formed into the workpiece 2, a back chamfer (not illustrated) may be formed into a rear side (i.e., the bottom surface 6) of the workpiece 2 that is opposite the (front) chamfer H4. In one embodiment, the tool 10 is partially retracted through the hole so that the boring tooth 25 is proximate to the bottom surface 6 of the workpiece 2, and then a back chamfer is milled or formed into the workpiece 2 via the interpolation of the boring tooth 25.

The foregoing material removal operation utilizing combination tool 10 is illustrated in FIGS. 2-3, and the parameters of each of the material removal processes therein are further detailed in FIG. 4. It will be appreciated, however, that the forgoing are merely examples, and that different parameters and/or values may instead be utilized.

It should be noted that the configuration of a particular material that an end user will perform a material removal operation on may exhibit different material properties than those of the present experiment. These material properties may govern the formation of the chip. To satisfy the requirements of the end user's material removal operation, various parameters of the tool 10 may be modified to further increase the efficiency of the overall material removal operation.

One or more of the cutting operations performed by the tool 10 may result in excessive chip or Swarf generation that may adversely impact operation. For example, utilization of a single point boring tool may cause long, continuous chips, or Swarf, that may wrap around the shank portion 18 or other proximal portions of the tool 10. Swarf wrapping around the tool 10 in this manner may impact tool rotation speed and/or rub against the workpiece 2 and damage the finish. The tool 10 may thus include one or more features that facilitate chip removal. For example, the tool 10 may include one or more features that inhibit Swarf from wrapping around the proximal end 12 of the tool, proximate to the shank portion 18. These Swarf inhibiting features may extend solely along the shank portion 18, but in some embodiments, may extend distally from the shank portion 18 into at least one of the Cutting Portions positioned distal from the shank portion. In the exemplary embodiment illustrated in FIG. 1, tool 10 includes a slot 50 formed into a periphery of the tool 10 and positioned near the proximal end 12 thereof, such that jetstream slot 50 extends along the central axis X through the shank portion 18 and into a proximal end of a flute of the chamfering portion 28; however, the slot 50 may extend into a different feature of the chamfering portion 28. The slot 50 is a channel formed into the periphery of the tool 10 and functions as a jetstream through which material (e.g., chips or Swarf) may flow as it is removed from the workpiece 2. Here, one (1) of the slots 50 is included, but in other embodiments, more of the slots 50 may be included. Also, the slot 50 (or any of them) may be arranged to extend through the distal-most Cutting Portion and into one or more distally positioned Cutting Portions. For example, one or more of the slots 50 may extend through the distal-most Cutting Portion and into at least a penultimate Cutting portion. Moreover, these slots 50 may extend into the Cutting Portion at a proximal portion of a flute thereof as illustrated in FIG. 1, or may extend into other proximal portions of the Cutting Portions. In some non-illustrated embodiments, the slot 50 terminates before reaching the proximal-most Cutting Portion of the tool 10. In addition to guiding and ushering the Swarf and other chips away from and out of the flutes of the tool 10, the slot 50 may also help as an alignment reference to help orient and position the tool 10.

The combination tool 10 may also include one or more features that facilitate chip breaking such that otherwise longer chips are broken into smaller discrete chips. Thus, the tool 10 may include chip breaker features. These chip breaker features may be positioned along the cutting edges of one or more of the Cutting Portions. In one example, the milling portion 22 includes chip breaker features positioned along the cutting edges thereof. The chip breaker features may be oriented to be approximately perpendicular to the central axis X, or may be angled (with reference to FIG. 1) in a clockwise direction thereto.

Material removal operations using conventional combination tools may involve tool pressures, surface finish conditions, tool wear, heat generation, dimensional inaccuracy, or combinations thereof that are undesirable. Such conditions may be exacerbated as material removal rates are increased to accommodate production volumes. The present disclosure is directed to tools that include a combination of elements that may improve the conditions experienced in material removal operations by modifying the chip creation and chip evacuation methodology as compared to conventional tools. Cutting elements that may be included on the drilling portion 20 of the tool 10 include a contoured drill point and an extended gash contour that is positioned along the lands of the drilling portion 20. By incorporating such elements into the drilling portion 20 of the tool 10, the tool 10 may modify the method of chip generation, such that cutting forces and temperatures at the workpiece 2 are reduced as compared to conventional tools. Further, holes produced by the drilling portions 20 may exhibit improved geometric conditions, positional tolerance, and/or surface condition.

As used herein, the term “about” means plus or minus 15% of the numerical value of the number with which it is being used. Therefore, “about 40” means “in the range of 34 to 46.” It is also noted that the terms “generally” and “substantially” may be used herein to represent the inherent degree of uncertainty that may be attributed to any quantitative comparison, value, measurement, or other representation. These terms are also used herein to represent the degree by which a quantitative representation may vary from a stated reference without resulting in a change in the basic function of the subject matter at issue.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

1. A cutting tool, comprising:
a drilling portion defining a drill diameter;
a milling portion defining a mill diameter; and
a boring portion defining a bore diameter;
wherein the mill diameter is smaller than the drill diameter.

2. The cutting tool of claim 1, wherein the bore diameter is greater than the mill diameter.

3. The cutting tool of claim 2, wherein the bore diameter is greater than the drill diameter.

4. The cutting tool of claim 1, wherein the milling portion is arranged between the drilling portion and the boring portion.

5. The cutting tool of claim 4, wherein the drilling portion arranged at an axial end of the cutting tool.

6. The cutting tool of claim 4, wherein a gap is arranged between the drilling portion and the milling portion.

7. The cutting tool of claim 4, wherein a gap is arranged between the milling portion and the boring portion.

8. The cutting tool of claim 1, wherein the cutting tool extends along a central axis from an axial end of the cutting tool, and wherein the drilling portion, the milling portion, and the boring portion each extend along the central axis, with the drilling portion extending from the axial end and the milling portion extending from the drilling portion.

9. The cutting tool of claim 1, further comprising a chamfering portion.

10. The cutting tool of claim 9, wherein the milling portion is arranged between the drilling portion and the boring portion, and the chamfering portion is arranged on a side of the boring portion that is opposite the milling portion.

11. The cutting tool of claim 10, wherein a gap is arranged between the boring portion and the chamfering portion.

12. The cutting tool of claim 10, further including a shank portion extending from the chamfering portion.

13. The cutting tool of claim 12, further including at least one jetstream that extends along at least a portion of the shank portion.

14. The cutting tool of claim 13, wherein the at least one jetstream extends into at least a portion of the chamfering portion.

15. The cutting tool of claim 1, wherein the cutting tool includes a material selected from the group consisting of tool steel, cemented tungsten carbide, and titanium.

16. A combination tool, comprising:
a shank portion extending along an axis; and
a cutting portion having an axial tip and extending along the axis from the shank portion to the axial tip, wherein the cutting portion includes:
a bore segment arranged along the cutting portion at a location proximate to the shank portion,
a drill segment arranged along the cutting portion at a location proximate to the axial tip,
an end mill segment arranged along the cutting portion at a location between the bore segment and the drill segment, and
a chamfer segment arranged along the cutting portion at a location between the bore segment and the shank portion.

17. (canceled)

18. (canceled)

19. A method of machining a workpiece using a cutting tool having a drill portion, a mill portion, and a bore portion, the method comprising:
drilling a hole in the workpiece with the drill portion;
milling the hole in the workpiece with the mill portion in an interpolated milling operation, wherein the mill portion includes a diameter that is smaller than a diameter of the drill portion; and
boring the hole in the work piece with the bore portion.

20. The method of claim 19, wherein the cutting tool further includes a chamfer portion, and wherein the method further includes chamfering the hole in the workpiece with the chamfer portion.

21. The cutting tool of claim 1, wherein the drilling portion, the milling portion, and the boring portion are configured along the axis to perform a drilling operation, a milling operation, and a boring operation, respectively, without removal or withdrawal of the cutting tool from a workpiece.

22. The cutting tool of claim 21, wherein the drilling operation, the milling operation, and the boring operation are, respectively, sequentially performed in rapid succession.

23. The combination tool of claim 16, further including at least one jetstream extending along at least part of the shank portion and into the chamfer segment.

24. The combination tool of claim 16, wherein a first gap is arranged between the mill segment and the bore segment and a second gap is arranged between the bore segment and the chamfer segment.
